(19) United States
(12) Patent Application Publication
(10) Pub. No.: US 2011/0298997 A1
(43) Pub. Date: Dec. 8, 2011

(54) SHUTTER EYEGLASSES

(75) Inventors: Hiroshi Ohno, Tokyo (JP); Tetsuya Tanaka, Tokyo (JP)

(73) Assignee: SONY CORPORATION, Tokyo (JP)

(21) Appl. No.: 13/117,189

(22) Filed: May 27, 2011

(30) Foreign Application Priority Data
Jun. 4, 2010 (JP) P2010-129422

(51) Int. Cl. G02F 1/1335

(52) U.S. Cl. 349/13

(57) ABSTRACT

Shutter eyeglasses include: liquid crystal lenses; a first polarizing plate attached to the back face of each of the liquid crystal lenses; an eyeglass frame which supports the liquid crystal lenses; and a second polarizing plate which is detachably attached to the front face of each of the liquid crystal lenses.

### BACKGROUND OF THE INVENTION

The present disclosure relates to shutter eyeglasses that a viewer of a stereoscopic picture in which right and left pictures are displayed in a time-division manner puts on, and particularly, to shutter eyeglasses in which a flicker that is generated due to outside light such as illuminating light is suppressed.

A stereoscopic picture that is seen in three dimensions by a viewer can be presented by displaying pictures having parallax on the right and left eyes. As one example of a method of presenting a stereoscopic picture, a method in which a viewer wears eyeglasses having special optical characteristics and images imparted with parallax are presented to both eyes can be provided. For example, a time-division stereoscopic picture display system includes a combination of a display device that displays a plurality of different pictures in a time-division manner and shutter eyeglasses that the viewer of the picture wears.

The display device alternately displays on a screen a picture for the right eye and a picture for the left eye for a very short period and at the same time, separately provides the pictures to the right eye and the left eye in synchronization with the periods of the picture for the right eye and the picture for the left eye. Meanwhile, the shutter eyeglasses worn by a viewer have a shutter mechanism which is constituted by a liquid crystal lens or the like, at each of a right eye portion and a left eye portion. In the shutter eyeglasses, during display of the picture for the left eye, the left eye portion of the shutter eyeglasses transmits light and the right eye portion shields light. Also, during display of the picture for the right eye, the right eye portion of the shutter eyeglasses transmits light and the left eye portion shields light (refer to Japanese Unexamined Patent Application Publication No. 09-138384, Japanese Unexamined Patent Application Publication No. 2000-36969, and Japanese Unexamined Patent Application Publication No. 2003-45343, for example). That is, a stereoscopic picture is presented to a viewer by performing time-division display of the picture for the right eye and the picture for the left eye by the display device and the shutter eyeglasses performing image selection through the shutter mechanisms in synchronization with display switching of the display device.

The display device that is used for the stereoscopic picture display is not limited to a specific method. For example, in addition to a traditional CRT (Cathode Ray Tube) display, a plasma display panel (PDP), a liquid crystal display (LCD), and an Electro-Luminescence (EL) panel can be used. Of these, as the liquid crystal display, an active matrix type liquid crystal display in which a TFT (Thin-Film Transistor) is disposed for each pixel is common. The TFT liquid crystal display performs display by driving each pixel by writing of a picture signal for every scanning line from the upper portion of a screen toward the lower portion thereof, and blocking or transmitting the illuminating light from a backlight at each pixel.

By attaching polarizing plates in front of and behind the lenses of the shutter eyeglasses, it is possible to block all light. As illustrated in FIG. 18, a polarizing plate is usually attached to the outermost surface of the liquid crystal display. On the other hand, a polarizing plate, in which the transmission axis is aligned with that of the polarizing plate on the liquid crystal display side, is attached to the front face (the surface on the liquid crystal display side) of each liquid crystal lens of the shutter eyeglasses. Then, since the polarization direction of transmitted light of the liquid crystal lens rotates 90 degrees, a polarizing plate with a transmission axis rotated by only 90 degrees is attached to the surface on the viewer side of the liquid crystal lens.

However, if the shutter eyeglasses are made to block all light, there is a problem in that a non-inverter type fluorescent lamp (and some LED lights) and the liquid crystal lens interfere with each other, so that intense flickering is generated. In the case of the shutter eyeglasses in which the polarizing plates are disposed in front of and behind the liquid crystal lens, when the shutters are closed, as illustrated in FIG. 19A, the shutter eyeglasses block all light. On the other hand, if the shutters are opened, as illustrated in FIG. 19B, since only the component, in which the polarization direction is aligned with a stereoscopic picture, of the incident light from the fluorescent lamp penetrates, a flicker is generated.

In FIG. 20A, the luminance of light which enters from the fluorescent lamp into the shutter eyeglasses is shown. In a case where the polarizing plates are disposed in front of and behind the liquid crystal lens, the light incident on the shutter eyeglasses penetrates only in a period in which the liquid crystal lens is opened, as illustrated in FIGS. 19A and 19B. In FIG. 20B, the luminance of light which penetrates the shutter eyeglasses in which the polarizing plates are disposed in front of and behind the liquid crystal lens, and is then received by the eyes of the viewer is shown. Since a luminance that is received by the eyes changes every time the shutter is opened, it can be found that a flicker is generated.

### SUMMARY OF THE INVENTION

It is desirable to provide excellent shutter eyeglasses in which a flicker that is generated due to outside light such as illuminating light can be suppressed.

According to an embodiment of the present disclosure, there is provided shutter eyeglasses including: liquid crystal lenses; a first polarizing plate attached to the back face of each of the liquid crystal lenses; an eyeglass frame which supports the liquid crystal lenses; and a second polarizing plate which is detachably attached to the front face of each of the liquid crystal lenses.

In the configuration of the shutter eyeglasses according to the embodiment of the present disclosure, the second polarizing plate may be attached by being inserted into a gap between the rim of the eyeglass frame and the liquid crystal lens.

In the configuration of the shutter eyeglasses according to the embodiment of the present disclosure, in the second polarizing plate, an insertion tab for insertion into the gap between the rim of the eyeglass frame and the liquid crystal lens may be formed at least one site.

In the configuration of the shutter eyeglasses according to the embodiment of the present disclosure, the second polarizing plate may have a concavity at least one location.

In the configuration of the shutter eyeglasses according to the embodiment of the present disclosure, the eyeglass frame may have rims which respectively surround the liquid crystal lenses for the right eye and the left eye. The shutter eyeglasses may further include a bridge which connects the second polarizing plates for the right eye and the left eye, and the second polarizing plates for the right eye and the left eye may be attached by clipping the rims at the bridge.

In the configuration of the shutter eyeglasses according to the embodiment of the present disclosure, the second polarizing plate may have a low-adhesive agent at the back face thereof and be detachably attached to the front face of the liquid crystal lens by the adhesive force of the low-adhesive agent.

In the configuration of the shutter eyeglasses according to the embodiment of the present disclosure, the second polarizing plate may have a detachable picking tab at the surface thereof.

According to the embodiment of the present disclosure, since by detachably attaching the second polarizing plates to the front faces of the liquid crystal lenses, the shutter eyeglasses are made to block only polarized light from the liquid crystal display, and it is possible to suppress a flicker which is generated due to outside light such as illuminating light.

On the other hand, if the second polarizing plates are not detachably attached to the front faces of the liquid crystal lenses, in a case where a viewer tilts the face, or the like, it is not possible to completely block polarized light from the liquid crystal display, so that a double image is easily observed. In contrast, according to an embodiment of the present disclosure, by making a viewer attach the polarizing plates to the front faces of the liquid crystal lenses of the shutter eyeglasses according to whether the problem of either flicker or crosstalk can be tolerated, it is possible to suppress the flicker or the crosstalk. That is, it is possible to freely respond to the problems of the flicker and the crosstalk in accordance with viewing environment.

Other purposes, features, and advantages of the present disclosure will become apparent from the more detailed description based on embodiments of the present disclosure, which will be described later, or the accompanying drawings.

### BRIEF DESCRIPTION OF THE DRAWINGS

FIG. 1A is a diagram illustrating a state when a shutter is closed in shutter eyeglasses in which a polarizing plate is disposed only on the back side of a liquid crystal lens.

FIG. 1B is a diagram illustrating a state when the shutter is opened in the shutter eyeglasses in which the polarizing plate is disposed only on the back side of the liquid crystal lens.

FIG. 1C is a diagram illustrating a state when the shutter is closed in a state where the shutter eyeglasses with the polarizing plate disposed only on the back side of the liquid crystal lens are tilted.

FIG. 1D is a diagram illustrating a state when the shutter is opened in a state where the shutter eyeglasses with the polarizing plate disposed only on the back side of the liquid crystal lens are tilted.

FIG. 2 is a diagram illustrating the appearance configuration of the shutter eyeglasses related to an embodiment of the present disclosure.

FIG. 3 is a diagram illustrating the polarizing plates which are attached using the insertion method to the front faces of the right and left liquid crystal lenses of the shutter eyeglasses.

FIG. 4 is a diagram illustrating the polarizing plates which are attached using the clipping method to the front faces of the right and left liquid crystal lenses of the shutter eyeglasses.

FIG. 5 is a diagram illustrating the polarizing plates which are attached using the adhesion method to the front faces of the right and left liquid crystal lenses of the shutter eyeglasses.

FIG. 6 is a diagram illustrating a configuration example of an insertion type polarizing plate attachment.

FIG. 7 is a diagram illustrating a configuration example of the insertion type polarizing plate attachment.

FIG. 8 is a diagram for illustrating how to insert the polarizing plate attachment into the shutter eyeglasses.

FIG. 9 is a diagram illustrating a state of attaching the insertion type polarizing plate attachment to the shutter eyeglasses.

FIG. 10 is a diagram illustrating a state of detaching the insertion type polarizing plate attachment from the shutter eyeglasses.

FIG. 11 is a diagram illustrating a configuration example of a clipping type polarizing plate attachment.

FIG. 12 is a diagram illustrating a configuration example of the clipping type polarizing plate attachment.

FIG. 13 is a diagram illustrating a configuration example of an adhesion type polarizing plate attachment.

FIG. 14 is a diagram illustrating a configuration example of the adhesion type polarizing plate attachment.

FIG. 15 is a diagram illustrating the adhesion type polarizing plate attachment provided with a picking tab.

FIG. 16 is a diagram illustrating a state of attaching the insertion type or the adhesion type polarizing plate attachment to the shutter eyeglasses.

FIG. 17 is a diagram illustrating a state of detaching the insertion type or the adhesion type polarizing plate attachment from the shutter eyeglasses.

FIG. 18 is a diagram illustrating a state where light from a stereoscopic picture which is displayed by a liquid crystal display reaches the eye of a viewer through a lens of the shutter eyeglasses.

FIG. 19A is a diagram for illustrating a phenomenon in which a flicker is generated in a stereoscopic picture due to the entrance of light of a fluorescent lamp into the shutter eyeglasses with the polarizing plates disposed in front of and behind the liquid crystal lens (at the time of closing of a shutter).

FIG. 19B is a diagram for illustrating a phenomenon in which a flicker is generated in a stereoscopic picture due to the entrance of light of the fluorescent lamp into the shutter eyeglasses with the polarizing plates disposed in front of and behind the liquid crystal lens (at the time of opening of the shutter).

FIG. 20A is a diagram illustrating the luminance of light which enters from the fluorescent lamp into the shutter eyeglasses.

FIG. 20B is a diagram illustrating the luminance of light which penetrates the shutter eyeglasses with the polarizing plates disposed in front of and behind the liquid crystal lens and is then received by the eyes of a viewer.

### DETAILED DESCRIPTION OF EMBODIMENTS

Hereinafter, embodiments of the present disclosure will be described in detail with reference to the drawings.

In a case where shutter eyeglasses block all light, there is a problem in that outside light from a fluorescent lamp or the like and the eyeglasses interfere with each other, whereby an intense flicker is generated (as described above). As one of the measures, removal of polarizing plates of the front faces of liquid crystal lenses of the shutter eyeglasses can be given.

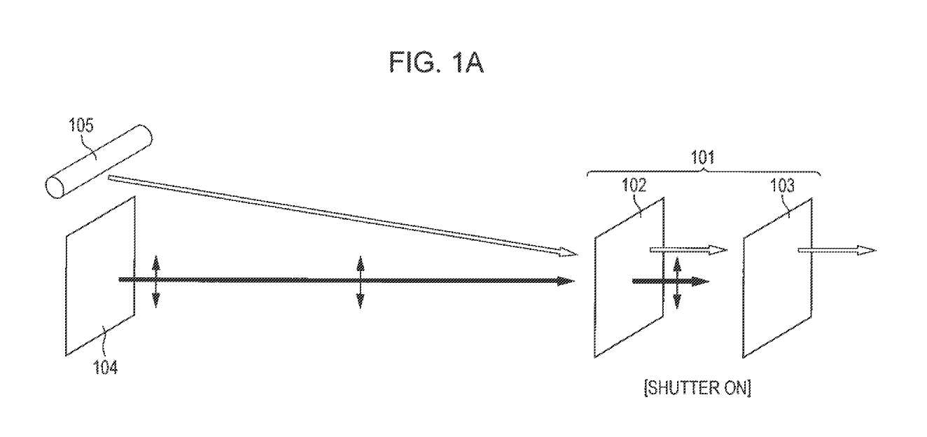

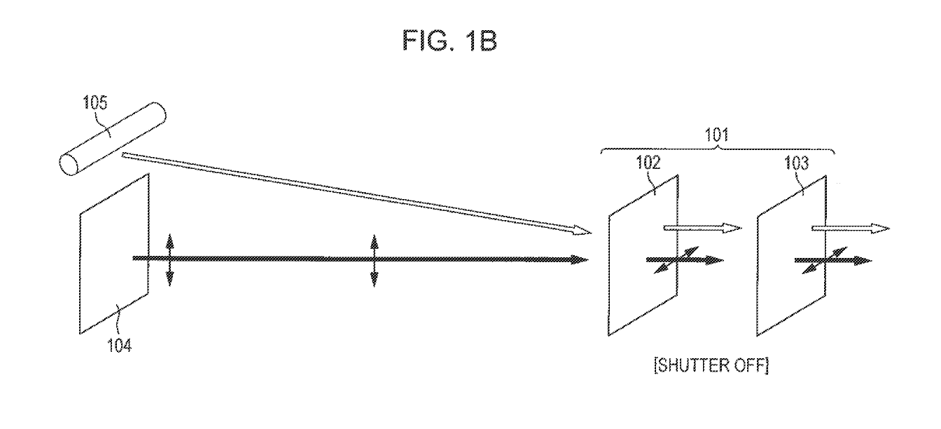

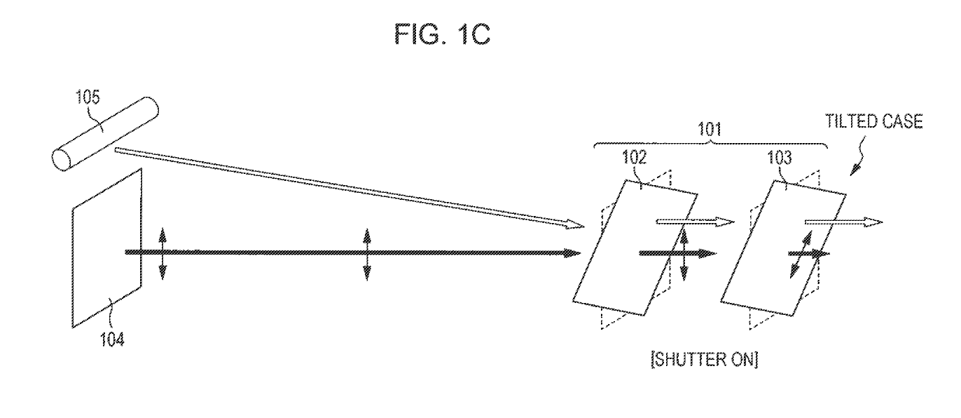

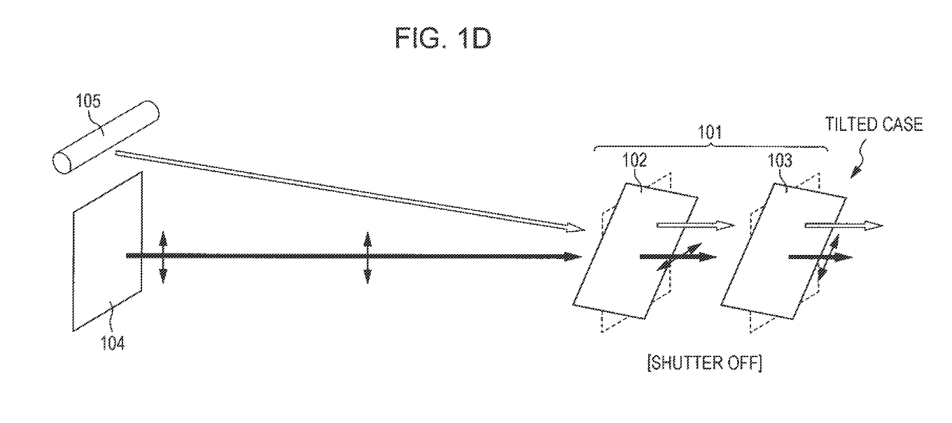

In FIG. 1A, a state when a shutter is closed in shutter eyeglasses 101 in which a polarizing plate 103 is disposed only on the back side of a liquid crystal lens is illustrated. Since light from a stereoscopic picture from a liquid crystal display 104 is polarized by a polarizing plate on the outermost surface, the light of the stereoscopic picture can be blocked only by the polarizing plate 103 attached to the back side (the surface on the viewer side) of a liquid crystal lens 102. On the other hand, since outside light from a fluorescent lamp 105 or the like is not blocked only by one sheet of polarizing plate 103, it is not possible to block the light in the shutter eyeglasses 101, and it reaches the eyes of a viewer. Also, in FIG. 1B, a state when the shutter is opened in the shutter eyeglasses 101 in which the polarizing plate 103 is disposed only on the back side of the liquid crystal lens 102 is illustrated. Both the light of the stereoscopic picture from the liquid crystal display 104 and the outside light from the fluorescent lamp 105 or the like penetrate the shutter eyeglasses 101. However, since the light of the stereoscopic picture is polarized, whereas the outside light from the fluorescent lamp 105 is not polarized, the flicker disappears.

However, if the polarizing plate 103 is attached only to the back side of the liquid crystal lens 102, there is a problem in that when the viewer wearing the shutter eyeglasses 101 performs action such as tilting their face, a double image is reflected in their eyes. If the viewer tilts their face, since both the liquid crystal lens 102 and the polarizing plate 103 of the shutter eyeglasses 101 are tilted, the polarization axis is deviated from the polarization axis of the stereoscopic picture of the liquid crystal display 104, so that it becomes not possible to completely block the light of the stereoscopic picture in a period in which the shutter is closed.

In FIG. 1C, a state when the shutter is closed in a state where the shutter eyeglasses 101 with the polarizing plate 103 disposed only on the back side of the liquid crystal lens are tilted is illustrated. Since the polarization axis of the polarizing plate 103 is tilted from the polarization axis of the polarizing plate on the outermost surface of the liquid crystal display 104, even if the shutter is closed, it is not possible to completely block the light of the stereoscopic picture from the liquid crystal display 104, so that the light reaches the eyes of the viewer. The outside light from the fluorescent lamp 105 or the like also reaches the eyes of the viewer. Also, in FIG. 1D, a state when the shutter is opened in a state where the shutter eyeglasses 101 with the polarizing plate 103 disposed only on the back side of the liquid crystal lens 102, are tilted is illustrated. Even when the shutter is opened, since the polarization axis of the polarizing plate 103 is tilted from the polarization axis of the polarizing plate on the outermost surface of the liquid crystal display 104, the light of the stereoscopic picture from the liquid crystal display 104 reaches the eyes of the viewer without being blocked. The outside light from the fluorescent lamp 105 or the like also reaches the eyes of the viewer. Accordingly, since both the picture for the right eye and the picture for the left eye are reflected in the right and left eyes of the viewer, crosstalk is generated, so that a double image is reflected in the eyes of the viewer.

Whether or not a flicker is generated by outside light also depends on whether or not a fluorescent lamp illuminating the interior of a room is an inverter type. Also, whether or not the polarizing axes of the shutter eyeglasses are tilted also depends on the method in which a viewer observes a stereoscopic picture. That is, whether either flicker or crosstalk is generated at the time of viewing of a stereoscopic picture does not necessarily depend only on the performance of the shutter eyeglasses. The inventors think that a viewer may personally decide whether the problem of either flicker or crosstalk can be tolerated.

Therefore, the inventors propose to make the polarizing plates of the front faces of the liquid crystal lenses of the shutter eyeglasses for viewing a stereoscopic picture be detachable. It is acceptable if a viewer attaches the polarizing plates to the front faces of the liquid crystal lenses of the shutter eyeglasses according to whether the problem of either flicker or crosstalk can be tolerated.

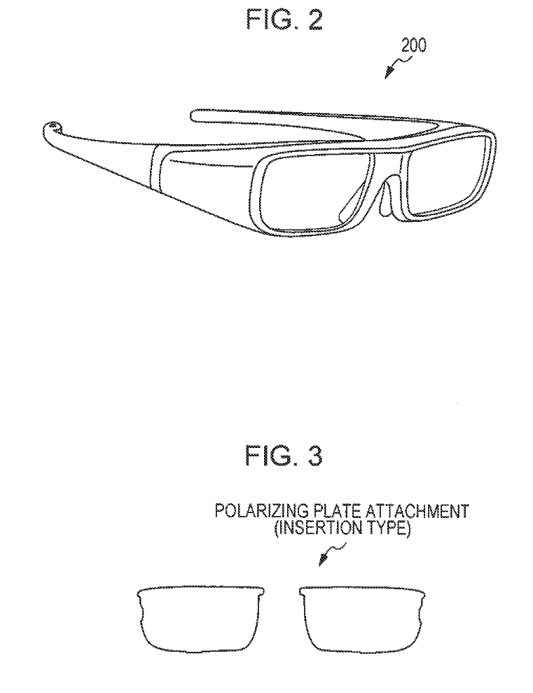

In FIG. 2, the appearance configuration of the shutter eyeglasses related to an embodiment of the present disclosure is illustrated. The illustrated configuration of an eyeglass frame is a general configuration. That is, an eyeglass frame 200 includes rims that surround the right and left lenses (in this case, the liquid crystal lenses), a bridge that connects the right and left rims, right and left temples pivotably joined through a hinge to the respective side edges at the outer corner sides of the eyes of the right and left rims, and temple tips which are put on the ears at end tips of the respective temples. Also, a hinge portion which supports the temple on the rim is covered by armor. Also, the right and left rims have nose pads at the inner corner sides of the eyes and are made to pinch the nose from both sides, thereby fixing the eyeglasses. The basic configuration itself of the eyeglass frame 200 is common knowledge.

Although it is omitted in FIG. 2, the polarizing plates 103 are attached to the back faces (the surfaces on the viewer side) of the liquid crystal lenses 102 which are respectively supported by the right and left rims.

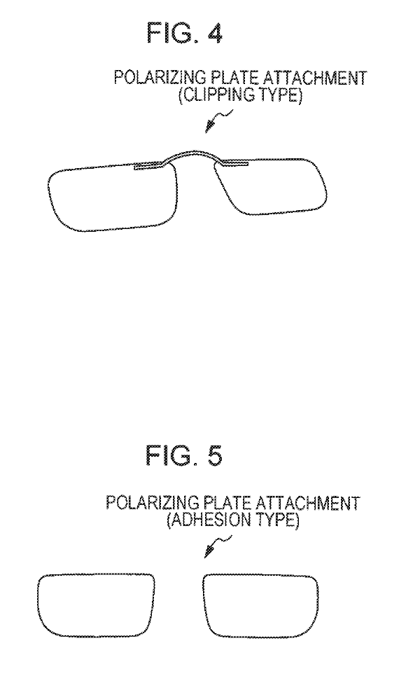

On the other hand, as a method of detachably attaching the polarizing plates to the front faces of the right and left liquid crystal lenses 102, for example, an insertion type (refer to FIG. 3), a clipping type (refer to FIG. 4), and an adhesion type (refer to FIG. 5) can be given. Hereinafter, each attachment method will be described.

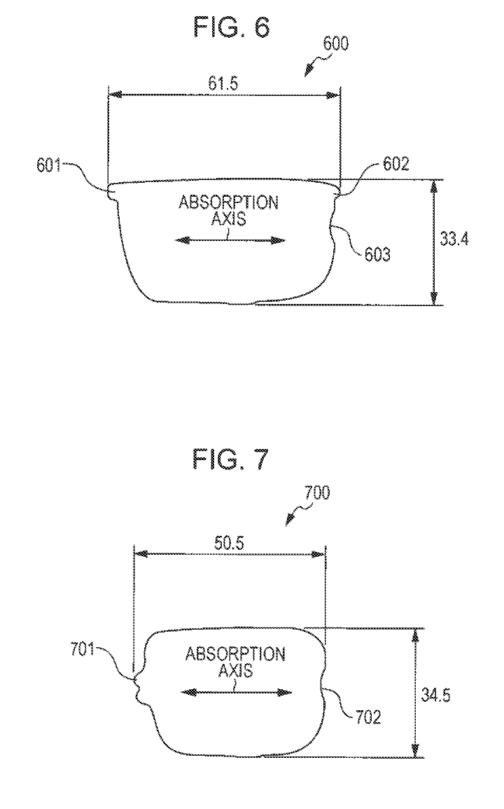

The insertion type is a method of attaching the polarizing plate attachment by inserting an end portion of the polarizing plate attachment into a gap between the liquid crystal lens and the rim. In FIGS. 6 and 7, configuration examples of an insertion type polarizing plate attachment are respectively illustrated. The actual size is arbitrarily determined in accordance with the shape or size of the rim. The direction of the absorption axis of the polarizing plate when it has been attached to the rim is set to approximately correspond with the absorption axis of the polarizing plate on the outermost surface of the liquid crystal display.

A polarizing plate attachment 600 illustrated in FIG. 6 is that of a regular size and a polarizing plate attachment 700 illustrated in FIG. 7 is that of a small size. In either type, insertion tabs 601, 602, and 701 are formed at an end portion on at least one side of the inner corner side of the eye and the outer corner side of the eye of the polarizing plate attachment. Also, in either type, concavities 603 and 702 are formed at the outer corner sides of the eyes.

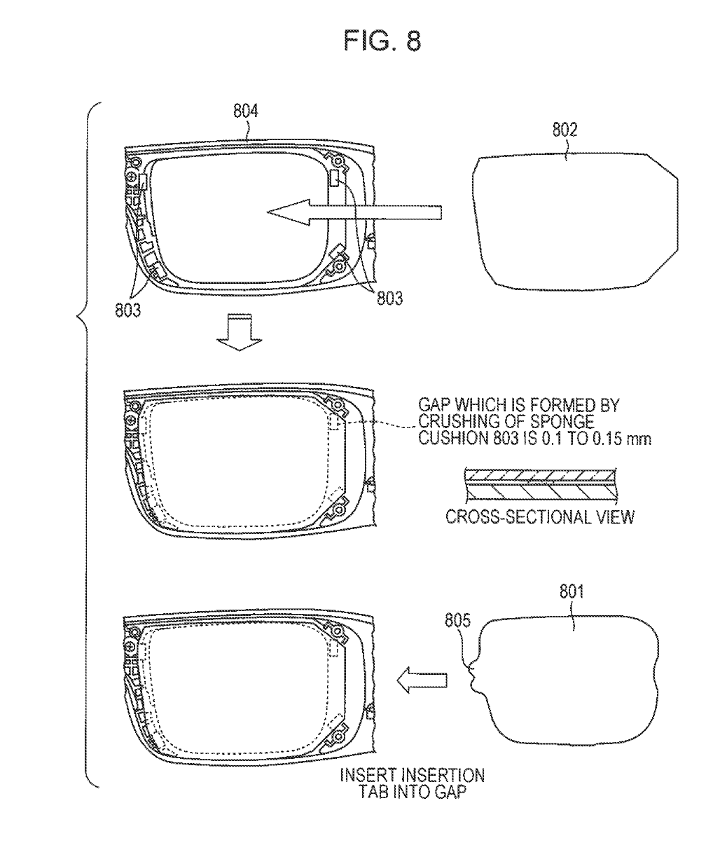

In FIG. 8, how a polarizing plate attachment 801 is inserted into the shutter eyeglasses is illustrated. A liquid crystal lens 802 is supported on a rim 804 of the eyeglass frame through a sponge cushion 803. If the sponge cushion 803 is crushed, a gap in the range of about 0.1 mm to 0.15 mm is formed between the surface of the liquid crystal lens 802 and the rim 804. The polarizing plate attachment 801 can be attached to the shutter eyeglasses by inserting an insertion tab 805 into the gap.

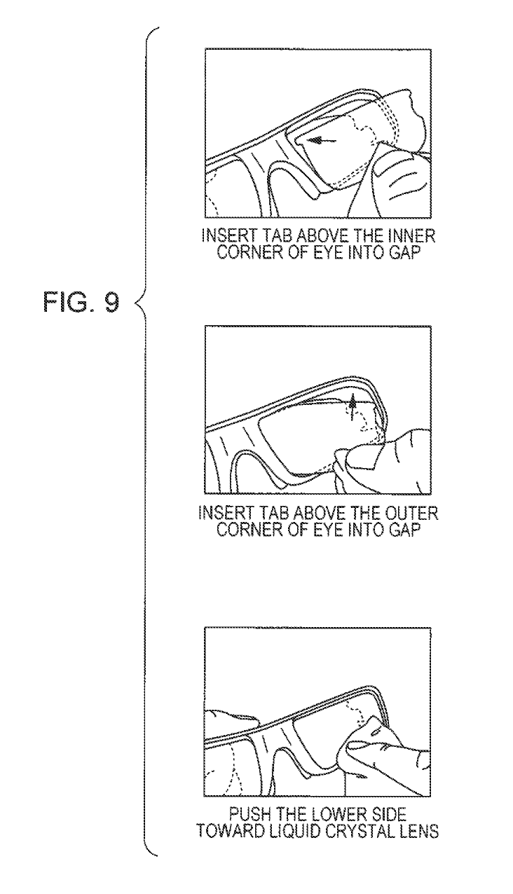

In FIG. 9, a state of attaching the insertion type polarizing plate attachment to the shutter eyeglasses is illustrated. However, the polarizing plate attachment which is used herein is set to be that of a regular size having the insertion tabs at both end portions on the inner corner side of the eye and the outer corner side of the eye, as illustrated in FIG. 6.

First, the insertion tab on the inner corner side of the eye of the polarizing plate attachment is inserted into the gap of the rim above the inner corner of the eye. Subsequently, the insertion tab at the outer corner sides of the eyes of the polarizing plate attachment is inserted into the gap of the rim above the outer corner of the eye. Then, by pushing the lower side of the polarizing plate attachment toward the liquid crystal lens, the polarizing plate attachment is fitted to the inner circumference of the rim and comes into close contact with the front face of the liquid crystal lens.

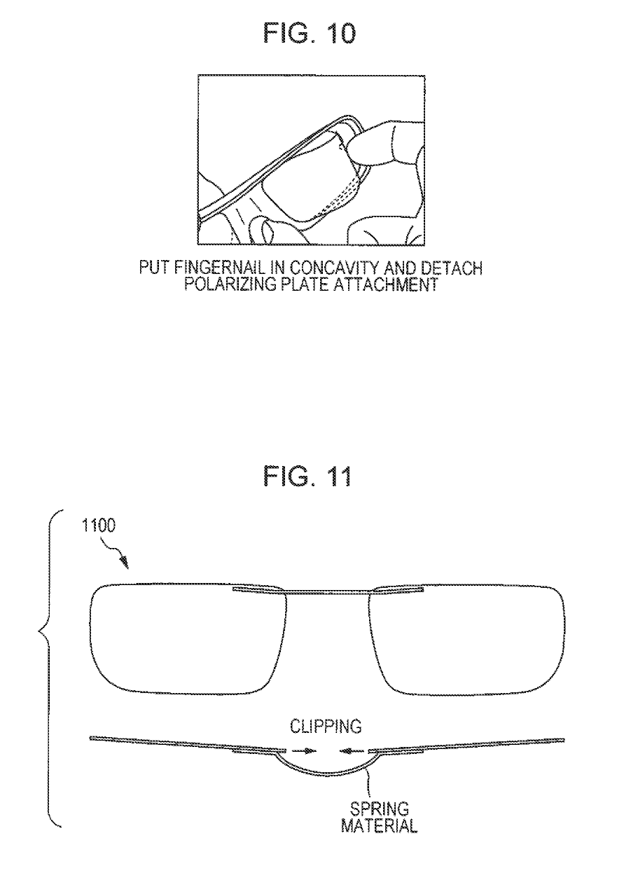

Also, in FIG. 10, a state of detaching the polarizing plate attachment attached in a manner as illustrated in FIG. 9 from the shutter eyeglasses is illustrated. As illustrated in the drawing, it is possible to put the fingernail in the concavity formed at the outer corner side of the eye and detach the polarizing plate attachment from the rim.

The clipping type is a method of attaching the polarizing plate attachment, in which the right and left polarizing plates are supported by a bridge made of a spring material, by clipping the rims on the shutter eyeglasses side at portions on the inner corner sides of the eyes with use of the elastic force of the bridge.

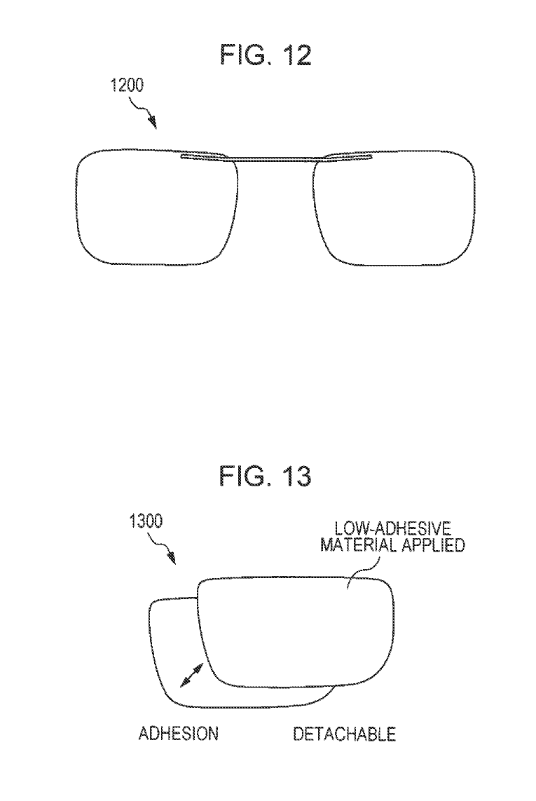

In FIGS. 11 and 12, configuration examples of a clipping type polarizing plate attachment are respectively illustrated. A polarizing plate attachment 1100 illustrated in FIG. 11 is that of a regular size and a polarizing plate attachment 1200 illustrated in FIG. 12 is that of a small size. The actual size is arbitrarily determined in accordance with the shape or size of the rim. The direction of the absorption axis of the polarizing plate when it has been attached to the rim is set to approximately correspond with the absorption axis of the polarizing plate on the outermost surface of the liquid crystal display. In addition, with regard to attachment methods and detachment methods of the clipping type polarizing plate attachments 1100 and 1200, illustration is omitted.

The adhesion type is a method of fixing the polarizing plate to the liquid crystal lens by the adhesive force of a low-adhesive agent applied to the back face side (the surface on the side which comes into contact with the liquid crystal lens) of the polarizing plate.

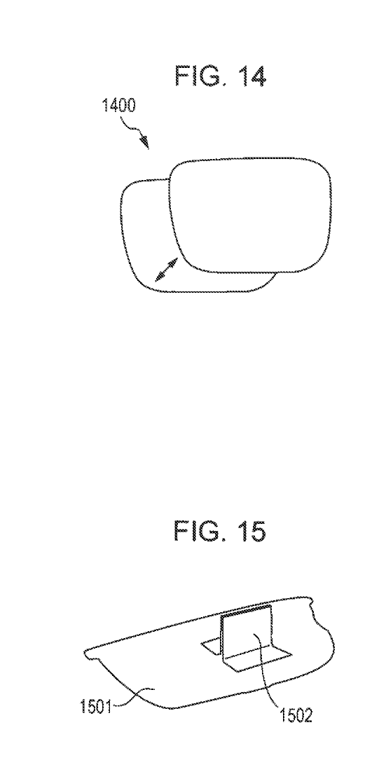

In FIGS. 13 and 14, configuration examples of an adhesion type polarizing plate attachment are respectively illustrated. A polarizing plate attachment 1300 illustrated in FIG. 13 is that of a regular size and a polarizing plate attachment 1400 illustrated in FIG. 14 is that of a small size. The actual size is arbitrarily determined in accordance with the shape or size of the rim.

In order to prevent a user from touching a surface, thereby soiling it by the hand, when attaching the insertion type or the adhesion type polarizing plate attachment to the shutter eyeglasses and when detaching it from the shutter eyeglasses, it is preferable to provide a picking tab 1502 at the approximate center of a polarizing plate 1501, as illustrated in FIG. 15. The picking tab 1502 is constituted by, for example, a two-folded adhesive tape. At the time of attachment and detachment, a user grips the picking tab 1502 and then manipulates the polarizing plate attachment 1501. However, after attachment, the user peels off the picking tab 1502 from the surface of the polarizing plate 1501 and then uses the shutter eyeglasses.

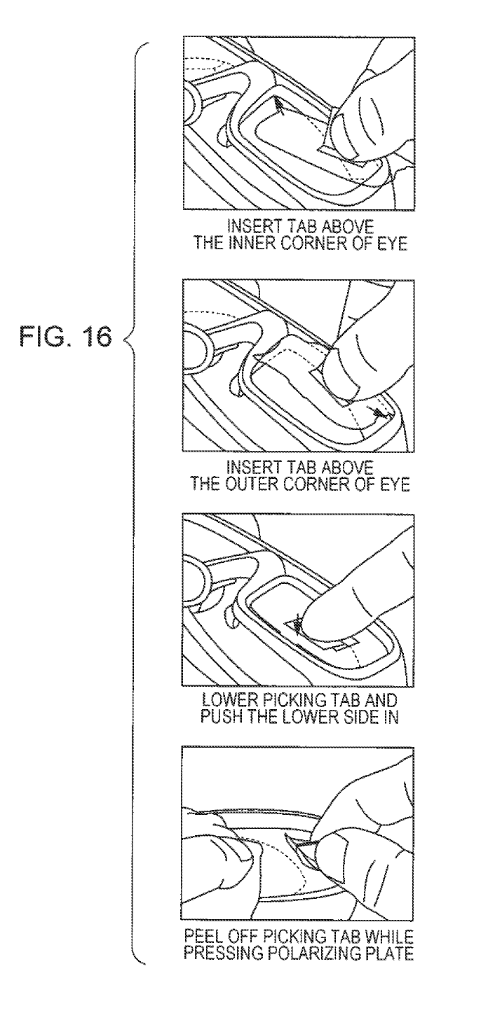

In FIG. 16, a state of attaching the insertion type or the adhesion type polarizing plate attachment to the shutter eyeglasses is illustrated.

First, a user grips the picking tab, lifts the polarizing plate, and then inserts the polarizing plate into the rim above the inner corner of the eye. Subsequently, if the user inserts the polarizing plate into the rim above the outer corner of the eye in a state where the user still grips the picking tab, the user then lowers the picking tab. Then, by pushing the approximate center of the polarizing plate by using the collapsed picking tab so as to prevent the fingertip from touching the surface of the polarizing plate, the polarizing plate attachment is fitted to the inner circumference of the rim and comes into close contact with the front face of the liquid crystal lens. After the polarizing plate attachment is attached to the liquid crystal lens, the user peels off the picking tab from the surface of the polarizing plate and then uses the shutter eyeglasses.

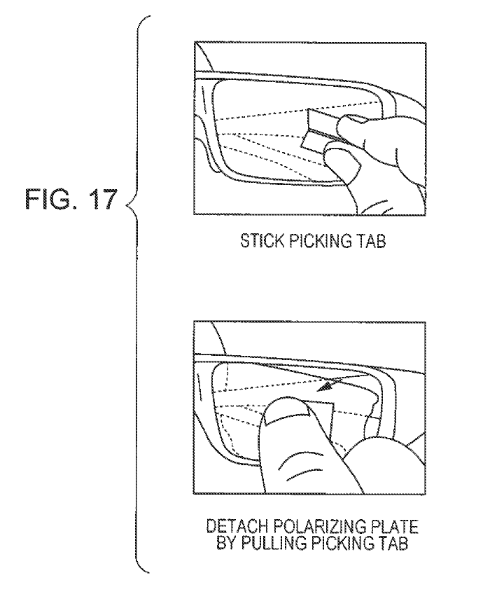

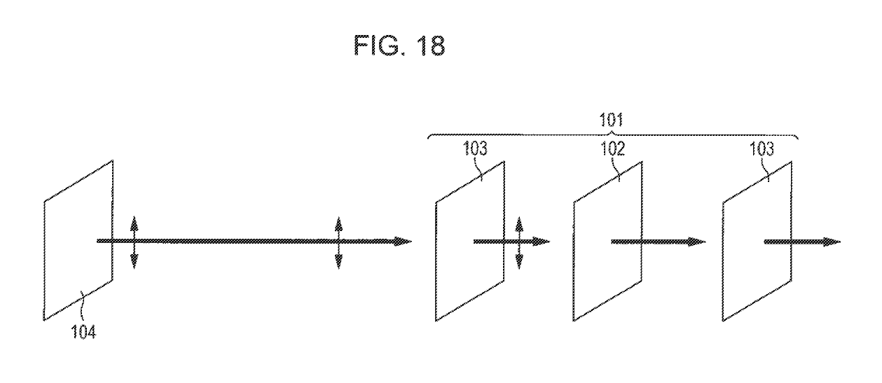

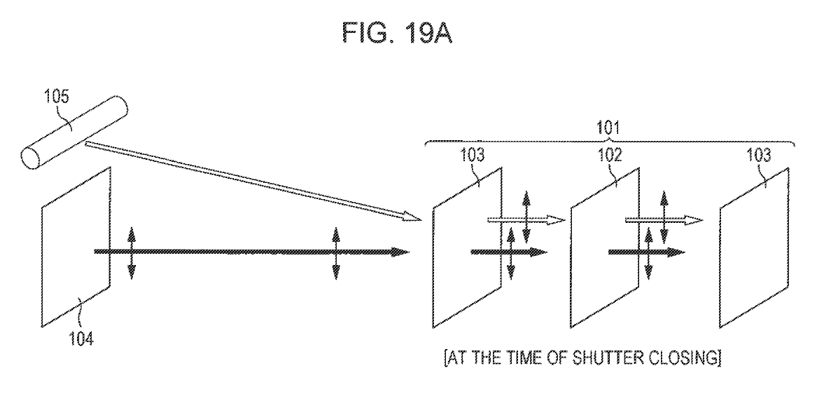

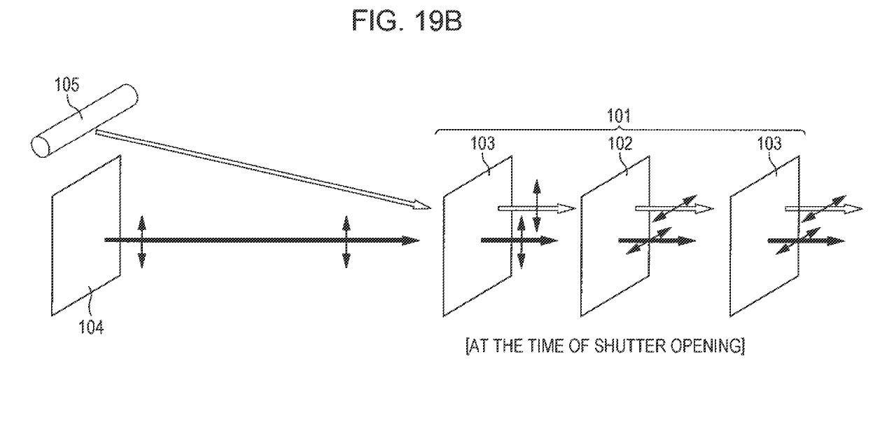

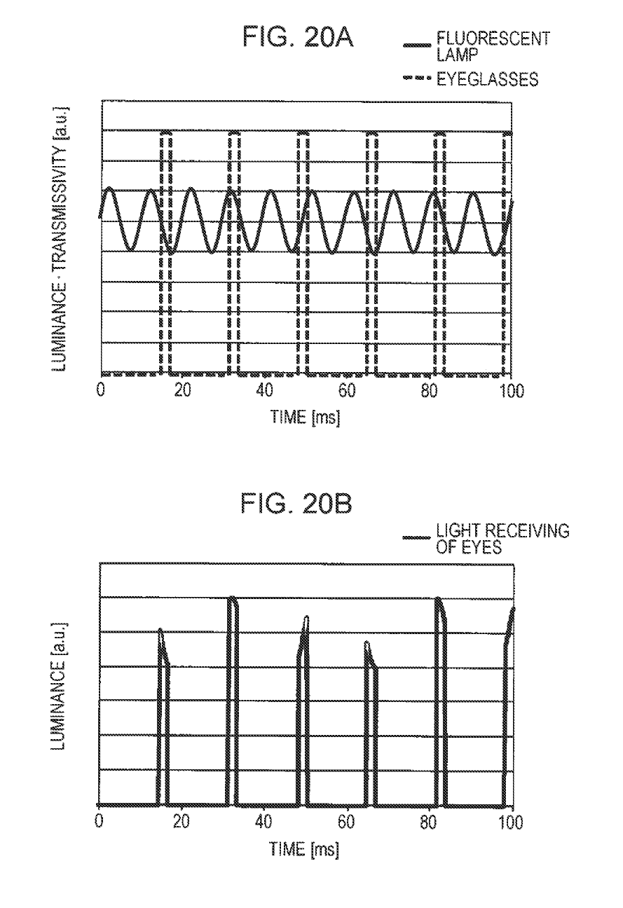

Also, in FIG. 17, a state of detaching the polarizing plate attachment attached in a manner as illustrated in FIG. 16 from the shutter eyeglasses is illustrated.

First, a user sticks the picking tab made of a two-folded adhesive tape to the approximate center of the polarizing plate attachment attached to the liquid crystal lens. Then, the user grips and pulls the picking tab while taking care that the fingertip does not touch the surface of the polarizing plate. Since the polarizing plate attachment is merely stuck to the surface of the liquid crystal lens by the low-adhesive agent, the polarizing plate attachment can be detached from the liquid crystal lens by the pulling force. Even after the detachment work is ended, in consideration of the next attachment of the polarizing plate attachment, the picking tab may remain stuck on.

Although in this specification, each of the insertion type, the clipping type, and the adhesion type polarizing plate attachments has been described with reference to the drawings, the gist of the present disclosure is not limited to the specific shapes or sizes of the illustrated polarizing plate attachments.

The present disclosure contains subject matter related to that disclosed in Japanese Priority Patent Application JP 2010-129422 filed in the Japan Patent Office on Jun. 4, 2010, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. Shutter eyeglasses comprising:
liquid crystal lenses;
a first polarizing plate attached to the back face of each of the liquid crystal lenses;
an eyeglass frame which supports the liquid crystal lenses; and
a second polarizing plate which is detachably attached to the front face of each of the liquid crystal lenses.

2. The shutter eyeglasses according to claim 1, wherein the second polarizing plate is attached by being inserted into a gap between the rim of the eyeglass frame and the liquid crystal lens.

3. The shutter eyeglasses according to claim 2, wherein in the second polarizing plate, an insertion tab for insertion into the gap between the rim of the eyeglass frame and the liquid crystal lens is formed at least one site.

4. The shutter eyeglasses according to claim 2, wherein the second polarizing plate has a concavity at least one location.

5. The shutter eyeglasses according to claim 1, wherein the eyeglass frame has rims which respectively surround the liquid crystal lenses for the right eye and the left eye,
the shutter eyeglasses further include a bridge which connects the second polarizing plates for the right eye and the left eye, and
the second polarizing plates for the right eye and the left eye are attached by clipping the rims at the bridge.

6. The shutter eyeglasses according to claim 1, wherein the second polarizing plate has a low-adhesive agent at the back face thereof and is detachably attached to the front face of the liquid crystal lens by the adhesive force of the low-adhesive agent.

7. The shutter eyeglasses according to claim 2, wherein the second polarizing plate has a detachable picking tab at the surface thereof.
